(19) United States
(12) Patent Application Publication
(10) Pub. No.: US 2006/0042551 A1
(43) Pub. Date: Mar. 2, 2006

(54) Animal waste management system and use thereof

(76) Inventor: Paul Moran, Neenah, WI (US)

Correspondence Address: MICHAEL BEST & FRIEDRICH, LLP, 100 E WISCONSIN AVENUE, MILWAUKEE, WI, 53202, US

(21) Appl. No.: 11/212,416

(22) Filed: Aug. 26, 2005

Related U.S. Application Data
(60) Provisional application No. 60/604,760, filed on Aug. 26, 2004.

(51) Int. Cl. A01K 29/00

(52) U.S. Cl. 119/166

(57) ABSTRACT

An animal waste management system including a pan and a liner. The pan includes a bottom surface and a plurality of side walls connected to the bottom surface and extending in an upward direction with respect to the bottom surface and forming a recess. The liner includes a bottom surface having a first portion and a second portion, the first portion oriented at an elevation different than the second portion, and a plurality of side walls connected to the bottom surface and extending in an upward direction with respect to the bottom surface and forming a recess, the liner oriented to be received in the recess of the pan.

### RELATED APPLICATIONS

This application is a non-provisional of and claims priority to U.S. Patent Application Ser. No. 60/604,760. The entire contents of U.S. Patent Application Ser. No. 60/604,760 are incorporated herein by reference.

### BACKGROUND

Litter boxes are commonly used by household or domestic pets, such as cats. Litter boxes are typically filled with litter or other materials to absorb urine and feces. Many types of litter box liners have been utilized with the litter box to reduce the amount of time it takes to clean the litter box or dispose of the litter.

### SUMMARY OF THE INVENTION

In one embodiment, the invention includes an animal waste management system comprising a pan and a liner. The pan includes a bottom surface and a plurality of side walls connected to the bottom surface and extending in an upward direction with respect to the bottom surface and forming a recess. The liner includes a bottom surface having a first portion and a second portion, the first portion oriented at an elevation different than the second portion, and a plurality of side walls connected to the bottom surface and extending in an upward direction with respect to the bottom surface and forming a recess, the liner oriented to be received in the recess of the pan.

In another embodiment, the invention includes an animal waste management system comprising a pan and a liner. The pan includes a bottom wall and a plurality of side walls connected to the bottom wall and extending in an upward direction with respect to the bottom wall and forming a recess. The liner includes a rigid polymer material and is infused with a fragrance, and is oriented to be received in the recess of the pan. The liner also includes a bottom wall, and a plurality of side walls connected to the bottom wall and extending in an upward direction with respect to the bottom wall and forming a recess adapted to receive litter.

In yet another embodiment, the invention includes a cat box litter pan liner. The liner includes a bottom wall having a first portion and a second portion, the first portion oriented at an elevation different than the second portion, the bottom wall comprised of a rigid polymer material. The liner also includes a plurality of side walls connected to the bottom wall and extending in an upward direction with respect to the bottom wall and forming a recess, the liner oriented to be received in a cat box litter pan.

### BRIEF DESCRIPTION OF THE DRAWINGS

FIG. 1 illustrates a perspective view of an animal waste management system according to one embodiment of the invention.

FIG. 2 illustrates an exploded view of the animal waste management system of FIG. 1.

FIG. 3 illustrates a perspective view of a liner of the animal waste management system of FIG. 1.

FIG. 4 illustrates a cross-sectional view of the liner of FIG. 3.

FIG. 5 illustrates a perspective view of the animal waste management system of FIG. 1 including a cover.

FIG. 6 illustrates an exploded view of the animal waste management system of FIGS. 1 and 5 including a fragrance dispenser system.

FIG. 7 illustrates a partial perspective view of a latching mechanism of the animal waste management system of FIGS. 1 and 5.

FIG. 8 illustrates an exploded view of the animal waste management system of FIGS. 1 and 5 including the fragrance dispenser system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling.

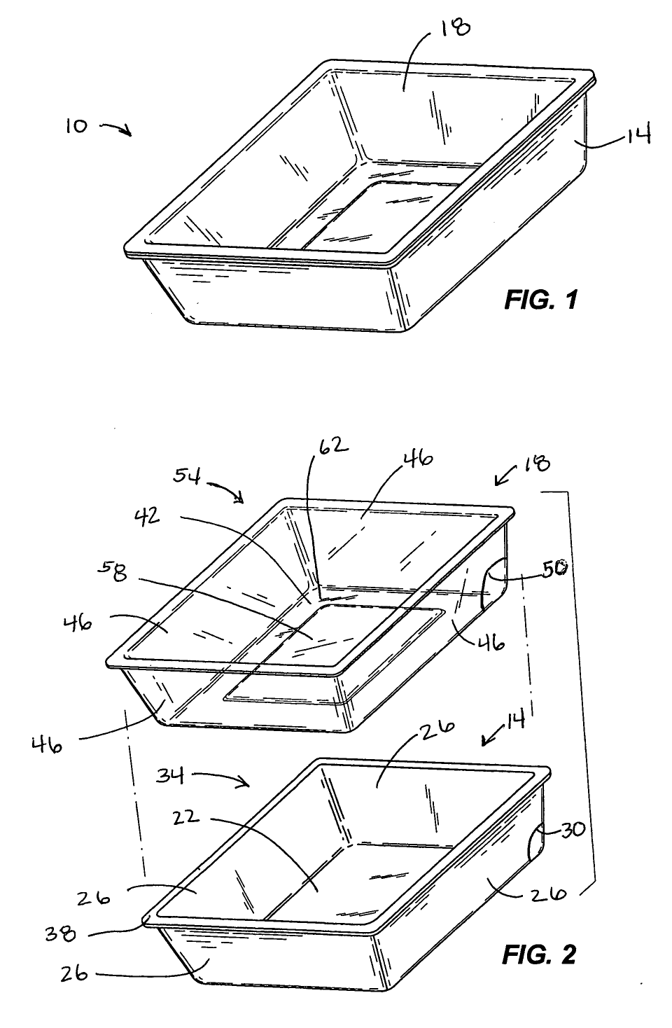

FIG. 1 illustrates an animal waste management system 10 according to one embodiment of the invention. The animal waste management system 10 includes a generally rigid box or pan 14 and a liner 18. The pan 14, in the construction illustrated in FIG. 2, is generally rectangular and includes a bottom wall 22 and a plurality of side walls 26 connected to the bottom wall 22. The side walls 26 extend in a generally vertical or upward direction with respect to the bottom wall 22. The side walls 26 can be oriented at an angle 30 with respect to the bottom wall 22. In one construction, the angle 30 can be in the range of about 85 degrees to about 145 degrees. In another construction, the angle 30 can be in the range of about 95 degrees to about 120 degrees. The bottom wall 22 and the side walls 26 define an inside portion or recess 34. The side walls 26 can extend to include a lip 38 that is oriented generally parallel to the bottom wall 22 of the pan 14. The pan 14 can vary in size and shape and is not limited to the size and shape illustrated in the FIGS.

The liner 18, in the construction illustrated in FIG. 2, is generally rectangular and is oriented to fit within the recess 34 of the pan 14. The liner 18 can vary in size and shape and is not limited to the size and shape illustrated in the FIGS. The liner 18 includes a bottom wall 42 and a plurality of side walls 46 connected to the bottom wall 42. The side walls 46 extend in a generally vertical or upward direction with respect to the bottom wall 42. The side walls 46 can be oriented at an angle 50 with respect to the bottom wall 42. In one construction, the angle 50 can be in the range of about 85 degrees to about 145 degrees. In another construction, the angle 50 can be in the range of about 95 degrees to about 120 degrees. The bottom wall 42 and the side walls 46 define an inside portion or recess 54. The bottom wall 42 includes a first portion 58 that is oriented at an elevation different than a second portion 62 of the bottom wall 42. In one construction, the first portion 58 can extend into the recess 54 of the liner 18.

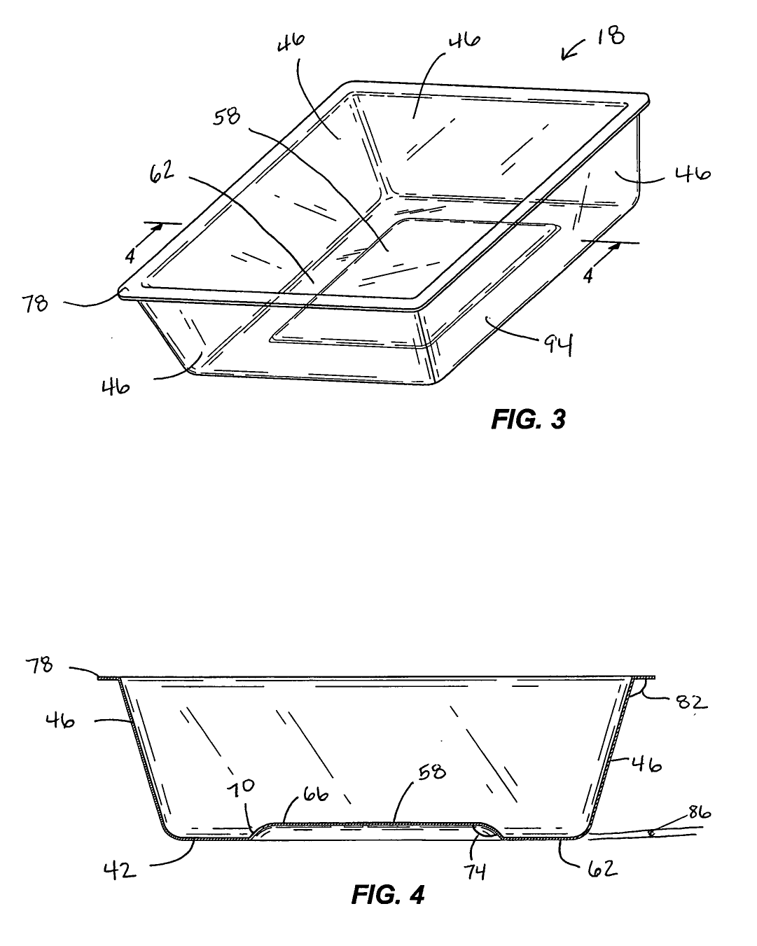

With reference to FIGS. 3 and 4, the first portion 58 can include a bottom wall 66 that is oriented generally parallel to the bottom wall 42 of the liner 18. The bottom wall 66 of the first portion 58 can be connected to the the second portion 62 of the bottom wall 42 with a plurality of side walls 70. The side walls 70 can be oriented at an angle 74 with respect to the bottom wall 66. In one construction, the angle 74 can be in the range of about 30 degrees to about 150 degrees. In another construction, the angle 74 can be in the range of about 100 degrees to about 120 degrees. The side walls 70 can be substantially planar and the ends of the side walls 70 can be radiused or curved to connect to the bottom wall 66 and the bottom wall 42.

In one construction of the liner 18, the first portion 58 can extend upwardly from the second portion 62 of the bottom wall 42 at an elevation that can be in the range of about 0.1 inches to about 1 inch. In another construction, the first portion 58 can extend upwardly from the second portion 62 of the bottom wall 42 at an elevation that can be in the range of about 0.2 inches to about 0.5 inches. The first portion 58, in the construction illustrated in FIG. 3, is generally rectangular and centered within the bottom wall 42 of the liner 18. The first portion 58 can be similar in shape to the bottom wall 42 of the liner 18, but can also vary. The first portion 58 can form a substantial portion of the bottom wall 42, yet the size of the first portion 58 can vary. The first portion 58 can provide structural stability to the liner 18. The side walls 46 can be extended to include a lip 78 that is oriented generally parallel with respect to the bottom wall 42. The lip 78 can provide for gripping the liner 18 for removal from the pan 14. The lip 78 can extend outward from the side walls 46 for a distance. In one construction, the distance can be in the range of about 0.25 inches to about 1 inch. In another construction, the distance can be in the range of about 0.5 inches to about 0.75 inches. The lip 78 can be oriented at an angle 82 with respect to the side walls 46. In one construction, the angle 82 can be in the range of about 45 degrees to about 120 degrees. In another construction, the angle 82 can be in the range of about 90 degrees to about 105 degrees.

The liner 18 can be manufactured from a plurality of materials, including but without limitation, plastics, recycled plastics, plastic resins, composites, and the like. The liner 18 can be manufactured by a plurality of processes, including but without limitation, stamping, pressing, extrusion, molding, casting, or otherwise formed as one element or as two or more elements coupled together in any manner. The liner 18 can be manufactured to have a thickness 86. In one construction, the thickness 86 can be in the range of about 0.001 inches to about 1.0 inches. In another construction, the thickness 86 can be in the range of about 0.05 inches to about 0.2 inches. It should also be noted that the thickness 86 does not need to be uniform throughout the entire liner 18. The thickness 86 can vary from one part of the liner 18 to another part of the liner 18. The thickness 86 of the liner 18 is adequate to support any amount of litter 90.

The liner 18 can hold the litter 90 that absorbs animal excrements, such as urine and feces. The liner 18 can be disposable or a throw-away device which eliminates the chore of repeatedly removing the animal excrements and cleaning the litter pan 14. Generally, pets urinate and/or excrete feces along the side walls 26 or on the bottom wall 22 of the pan 14 making it a difficult chore to clean the side walls 26 and the bottom wall 22 and to completely remove all excrements.

As illustrated in FIG. 2, the pet owner can dispose of the liner 18 without having to clean the side walls 26 or the bottom wall 22. The pet owner can take the animal waste management system 10 to a refuse container to dispose of the liner 18 and the soiled litter 90. Alternatively, the pet owner can use the lip 78 to lift out the liner 18 from the pan 14 to dispose of the liner 18, the soiled litter 90, and the pet excrements without having to take the entire animal waste management system 10 comprising the pan 14 and the liner 18 to the refuse container. Accordingly, when the pet owner determines that the litter 90 has reached a maximum excrement capacity, the pet owner need only dispose of the liner 18 and its contents. A new liner 18 can then be placed in the pan 14 and filled with litter 90 for virtually uninterrupted animal excrement usage.

The liner 18 can be infused with a scent or fragrance 94 for masking malodors, according to one embodiment of the invention. The fragrance 94 can include a scent, such as catnip, floral, powder, and the like. The fragrance 94 can be infused through a plurality of processes, including but without limitation, the controlled migration and release of fragrance 94 from a polymer matrix.

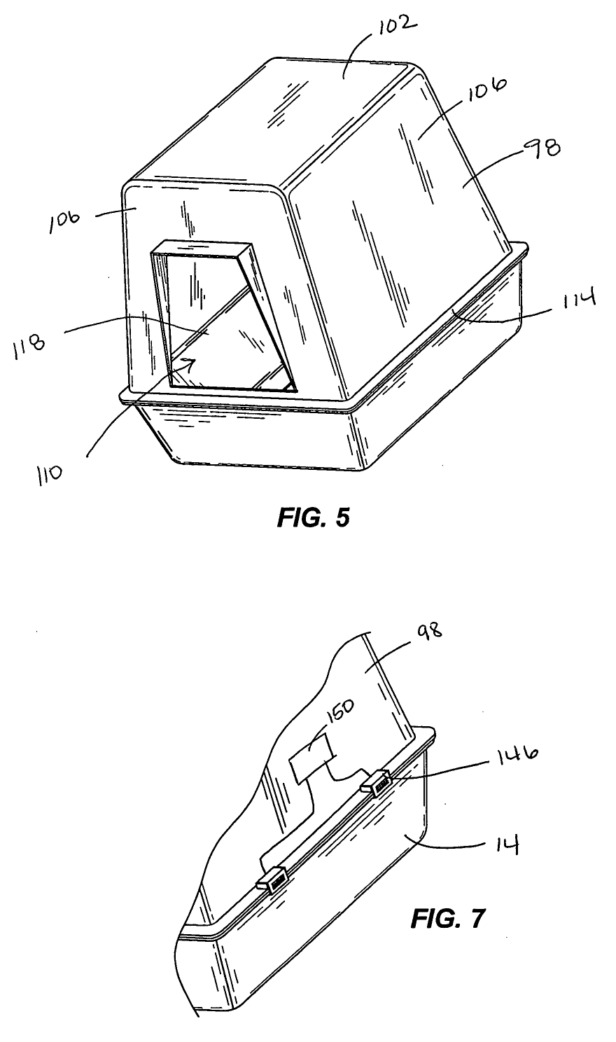

The animal waste management system 10 can include a cover 98, according to one embodiment of the invention. With reference to FIG. 5, the cover 98 can include a top wall 102 and a plurality of side walls 106 that are connected to the top wall 102. At least one of the side walls 106 includes an opening 110. The cover 98 can include a lip 114 that can be supported on the lip 38 on the pan 14 and/or the lip 78 on the liner 18. A cavity 118 is defined when the cover 98 is positioned on the pan 14, and the pet can access the cavity 118 via the opening 110. The cover 98 can be secured to the pan 14 with clips, adhesives, magnets, and the like. The cover 98 can be used with or without the liner 18.

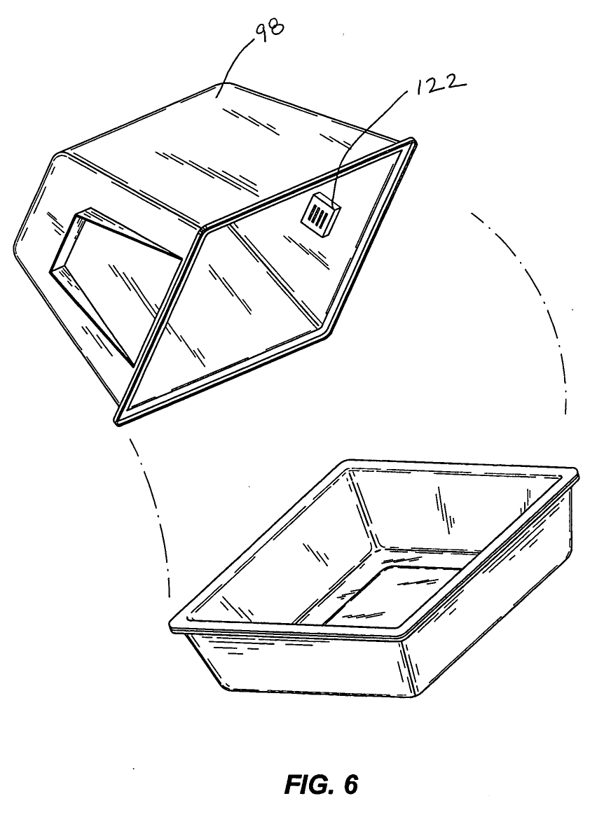

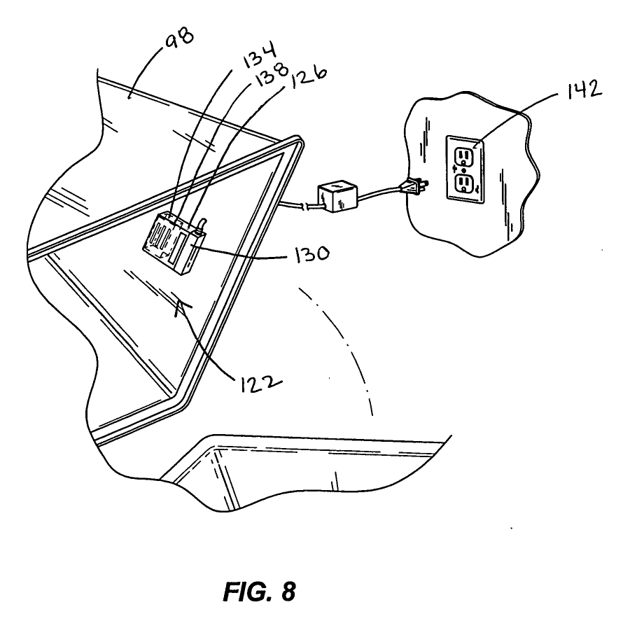

The cover 98 can include a fragrance dispenser system 122 as illustrated in FIGS. 6 and 8. The fragrance dispenser system 122 can be coupled to and/or embedded within the cover 98. In the construction illustrated in FIGS. 6 and 8, the fragrance dispenser system 122 is within the cavity 118, however, the fragrance dispenser system 122 can be positioned on the exterior of the cover 98 or in any suitable location on any of the components in the animal waste management system 10. With reference to FIG. 8, the fragrance dispenser system 122 can include a receptacle 126 and a heating element 130 that can be supported by the receptacle 126. The receptacle 126 can support a container 134 including a fragrance 138. The container 134 can be removed and replaced with a new or different container 134. The fragrance 138 can be in the form of a solid, a liquid, or a combination of a solid and a liquid.

The fragrance dispenser system 122 can connect to a power source 142, such as a standard electrical AC outlet. In the construction illustrated in FIG. 8, the fragrance dispenser sytem 122 can be connected to the power source 142 with an electrical cord. In other constructions, the fragrance dispenser system 122 can include a receptacle for at least one battery to be powered by the battery. The heating element 130 can be powered with AC power or DC power. When powered, the heating element 130 provides heat to the fragrance 138 within the container 134 such that the fragrance scent can be diffused to an area in and/or around the animal waste management system 10. The fragrance dispenser system 122, in some constructions, can diffuse the fragrance 138 into the area in and/or around the animal waste management system 10 without a separate power source 142 to power the fragrance dispenser system 110.

With reference to FIG. 7, the litter box cover 98 can include at least one latch mechanism 146, which couples the cover 98 to the pan 14. The liner 18 can be supported by the pan 14. The latch mechanism 146 provides a means to securely attach the cover 98 to the pan 14 while allowing the cover 98 to be easily removable from the pan 14. The latch mechanism 146 can include, for example, a bar that fits into a notch or slot and is lifted from either side by a lever or string, a spring lock that is opened from the outside by a key, a magnet, an interlocking rim, a latch, a pin, a clip, a fastener, or any other like device that can hold the cover 98 onto the pan 14. The latch mechanism 146 can be coupled to a member 150 that can deactivate, release, and/or open the latch mechanism 146 to allow the cover 98 to be removed from the pan 14. In some constructions, the member 150 can include an electrical mechanism that is connected to all of the latch mechanisms 146 and that when activated opens all of the latch mechanisms 146. The latch mechanisms 146 can be opened simultaneously or sequentially, but no particular order is required. In some construction, the member 150 can include a button that is connected to all of the latch mechanisms 146 and that when activated opens all of the latch mechanisms 146. The cover 98 can be removed from the pan 14 when all of the latch mechanisms 146 are open and/or released, thereby providing access to the cavity 118 and the liner 18.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. An animal waste management system comprising:
a pan including
a bottom wall, and
a plurality of side walls connected to the bottom wall and extending in an upward direction with respect to the bottom wall and forming a recess; and
a liner including
a bottom wall having a first portion and a second portion, the first portion oriented at an elevation different than the second portion, and
a plurality of side walls connected to the bottom wall and extending in an upward direction with respect to the bottom wall and forming a recess, the liner oriented to be received in the recess of the pan.

2. The animal waste management system of claim 1 wherein the liner is infused with a fragrance.

3. The animal waste management system of claim 1 wherein the first portion of the bottom wall of the liner extends upwardly from the second portion of the bottom wall of the liner in a range of about 0.1 inches to about 1 inch.

4. The animal waste management system of claim 1 wherein the first portion of the bottom wall of the liner extends upwardly from the second portion of the bottom wall of the liner in a range of about 0.2 inches to about 0.5 inches.

5. The animal waste management system of claim 1 wherein the first portion of the bottom wall of the liner is substantially rectangular-shaped and centered within the bottom wall.

6. The animal waste management system of claim 1 wherein the first portion of the bottom wall of the liner is connected to the second portion of the bottom wall of the liner with a side wall.

7. The animal waste management system of claim 6 wherein the first portion includes a bottom surface and wherein the side wall is oriented at an angle in the range of about 100 degrees to about 150 degrees with respect to the bottom surface of the first portion of the liner.

8. The animal waste management system of claim 6 wherein the side wall is substantially planar and wherein the connection between the side wall and the bottom wall of the first portion of the liner is arcuate.

9. The animal waste management system of claim 1 wherein the plurality of side walls of the liner are oriented at an angle in the range of about 85 degrees to about 145 degrees with respect to the bottom wall of the liner.

10. The animal waste management system of claim 1 wherein the liner and the pan are substantially rectangular-shaped.

12. The animal waste management system of claim 1 wherein the liner includes a lip that extends outwardly from at least one of the side walls of the liner, the lip oriented at an angle in the range of about 45 degrees to about 120 degrees with respect to the side wall.

13. The animal waste management system of claim 1 wherein the liner is comprised of a polymer material at a thickness in the range of about 0.001 inches to about 1 inch.

14. The animal waste management system of claim 1 further comprising a cover adapted to be secured to the pan and defining an opening and a cavity, an animal accessing the cavity through the opening.

15. The animal waste management system of claim 14 and further comprising a fragrance dispenser system coupled to the cover.

16. The animal waste management system of claim 15 wherein the fragrance dispenser system is positioned in the cavity.

17. The animal waste management system of claim 14 wherein the fragrance dispenser system includes a receptacle to support a fragrance and a heating element being powered by a power source to heat the fragrance.

18. The animal waste management system of claim 14 wherein the cover is secured to the pan with a plurality of latch mechanisms coupled to a member, the plurality of latch mechanisms adapted to be opened with activation of the member.

19. An animal waste management system comprising:
a pan including
a bottom wall, and
a plurality of side walls connected to the bottom wall and extending in an upward direction with respect to the bottom wall and forming a recess; and
a liner oriented to be received in the recess of the pan, the liner comprised of a rigid polymer material and being infused with a fragrance, the liner including
a bottom wall, and
a plurality of side walls connected to the bottom wall and extending in an upward direction with respect to the bottom wall and forming a recess adapted to receive litter.

20. A cat box litter pan liner comprising:
a bottom wall having a first portion and a second portion, the first portion oriented at an elevation different than the second portion, the bottom wall comprised of a rigid polymer material; and
a plurality of side walls connected to the bottom wall and extending in an upward direction with respect to the bottom wall and forming a recess, the liner oriented to be received in a cat box litter pan.
